(19) United States
(12) Patent Application Publication
(10) Pub. No.: US 2012/0170432 A1
(43) Pub. Date: Jul. 5, 2012

(54) READ POWER CONTROL

(75) Inventors: John Erik Hershey, Ballston Lake, NY (US); Kenneth Brakeley Welles, Scotia, NY (US); Xiaolei Shi, Niskayuna, NY (US); Zhiyuan Ren, Malta, NY (US); Victor Petrovich Ostroverkhov, Ballston Lake, NY (US)

(73) Assignee: GENERAL ELECTRIC COMPANY, Schenectady, NY (US)

(21) Appl. No.: 12/981,270

(22) Filed: Dec. 29, 2010

(51) Int. Cl. G11B 7/00

(52) U.S. Cl. 369/47.5; 369/103; G9B/7

(57) ABSTRACT

Techniques are provided for controlling the reading of micro-holograms from a holographic disk based on a target data layer to be read in the disk. Reading a target data layer which is relatively deeper in the disk (e.g., farther from an optical head emitting a reading beam) may involve using a higher power reading beam to compensate for power attenuation of the returned reading beam. For example, a power adjustment module may be used to dynamically adjust a reading laser emitting the reading beam, based on the dynamically changing target data layer. By compensating for power attenuation in deeper target data layers, the variance of power in the returned reading beams may be decreased, possibly improving the bit error rate in micro-hologram reading techniques.

### BACKGROUND

The present techniques relate generally to bit-wise holographic data storage techniques. More specifically, the techniques relate to methods and systems for read power control of holographic disks.

As computing power has advanced, computing technology has entered new application areas, such as consumer video, data archiving, document storage, imaging, and movie production, among others. These applications have provided a continuing push to develop data storage techniques that have increased storage capacity and increased data rates.

One example of the developments in data storage technologies may be the progressively higher storage capacities for optical storage systems. For example, the compact disc, developed in the early 1980s, has a capacity of around 650-700 MB of data, or around 74-80 minutes of a two channel audio program. In comparison, the digital versatile disc (DVD) format, developed in the early 1990s, has a capacity of around 4.7 GB (single layer) or 8.5 GB (dual layer). Furthermore, even higher capacity storage techniques have been developed to meet increasing demands, such as the demand for higher resolution video formats. For example, high-capacity recording formats such as the Blu-ray Disc™ format is capable of holding about 25 GB in a single-layer disk, or 50 GB in a dual-layer disk. As computing technologies continue to develop, storage media with even higher capacities may be desired. Holographic storage systems and micro-holographic storage systems are examples of other developing storage technologies that may achieve increased capacity requirements in the storage industry.

Holographic storage is the storage of data in the form of holograms, which are images of three dimensional interference patterns created by the intersection of two beams of light in a photosensitive storage medium. Both page-based holographic techniques and bit-wise holographic techniques have been pursued. In page-based holographic data storage, a signal beam containing digitally encoded data (e.g., a plurality of bits) is superposed on a reference beam within the volume of the storage medium resulting in a chemical reaction which modulates the refractive index of the medium within the volume. Each bit is therefore generally stored as a part of the interference pattern. In bit-wise holography or micro-holographic data storage, every bit is written as a micro-hologram, or Bragg reflection grating, typically generated by two counter-propagating focused recording beams. The data is then retrieved by using a read beam to reflect off the micro-hologram to reconstruct the recording beam.

Bit-wise holographic systems may enable the recording of closer spaced and layer-focused micro-holograms, thus providing much higher storage capacities than prior optical systems. Some configurations of holographic storage disks involve storing micro-holograms in multiple data layers, each having multiple parallel tracks. However, holographic storage disks typically have variations which may result in an increased bit error rate during holographic reading. For example, attenuation of the reading beam through the multiple data layers of the holographic storage disk may result in variations in the power of the returned read beam. Moreover, due to the multiple data layers in a holographic storage disk, such variations may be particularly susceptible to read errors. Techniques for reducing error rates in micro-holographic reading techniques may be advantageous.

### BRIEF DESCRIPTION

An embodiment of the present techniques provides a method of reading data in a holographic disk. The method includes adjusting a previous power of a reading beam to a new power based on the target data layer and emitting the reading beam at the new power to the target data layer on the holographic disk.

Another embodiment provides a system for reading micro-holograms on a holographic disk. The system includes a power adjust module configured to receive an instruction corresponding to a target data layer to be read from the holographic disk and adjust a power of a reading beam from a first power to a second power based on the instruction. The system also includes an optical head configured to direct the reading beam from a previous data layer of the holographic disk to the target data layer and focus the reading beam on the target data layer and an actuator configured to move a component of the optical head.

Another embodiment provides a method including determining a reading power of a reading beam suitable for reading the target data layer, such that a returned power of a returned reading beam is not significantly attenuated. The method then includes transmitting the reading beam at the reading power to the target data layer in the holographic disk.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a holographic storage system, in accordance with embodiments;

FIG. 2 illustrates a holographic disk having data tracks, in accordance with embodiments;

FIG. 3 illustrates multiple data layers of a holographic disk, in accordance with embodiments;

FIG. 4 is a graph of power distribution of a returned read beam without read power control;

FIG. 5 is a schematic diagram of a holographic reading system using read power control, in accordance with embodiments; and

FIG. 6 is a graph of power distribution of a returned read beam employing read power control, in accordance with embodiments.

### DETAILED DESCRIPTION

One or more embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for one of ordinary skill having the benefit of this disclosure.

Data in a holographic storage system is stored within a photosensitive optical material using an optical interference pattern that allows data bits to be stored throughout the volume of the optical material. Data transfer rates in a holographic storage system may be improved, as millions of bits of holographic data may be written and read in parallel. Furthermore, multilayer recording in holographic storage systems may increase storage capacity, as holographic data may be stored in multiple layers of an optical disc. To record data in a holographic storage system, a recording beam (e.g., a laser) may be directed to a particular depth in the media and focused on a target layer, or the layer on which data is to be recorded. The laser may also be focused on a target point or position on the target layer. The laser generates a photochemical change at the layer and/or position where the laser is focused, writing the data. In some holographic storage disk configurations, the disk includes dye material in the writable portion of the substrate, and the recording beam converts the dye material into a micro-hologram.

To read data in a multilayer holographic storage system, a reading beam may be directed to a data bit position (i.e., the target data position) at a particular layer (i.e., the target data layer) in a holographic disk, and the reading beam may pass through the surface of the holographic disk to interact with the material at the data bit position. The interaction of the reading beam at the target data layer may result in a scattering and/or reflecting of the reading beam from the data bit position in the holographic disk. The scattered and/or reflected portions of the reading beam may be referred to as a reflected reading beam or a returned reading beam and may be proportional to an initial recording beam that recorded the holographic data bit in the data bit position. As such, the reflected reading beam may be detected to reconstruct the data originally recorded in the data bit position on which the reading beam is impinged.

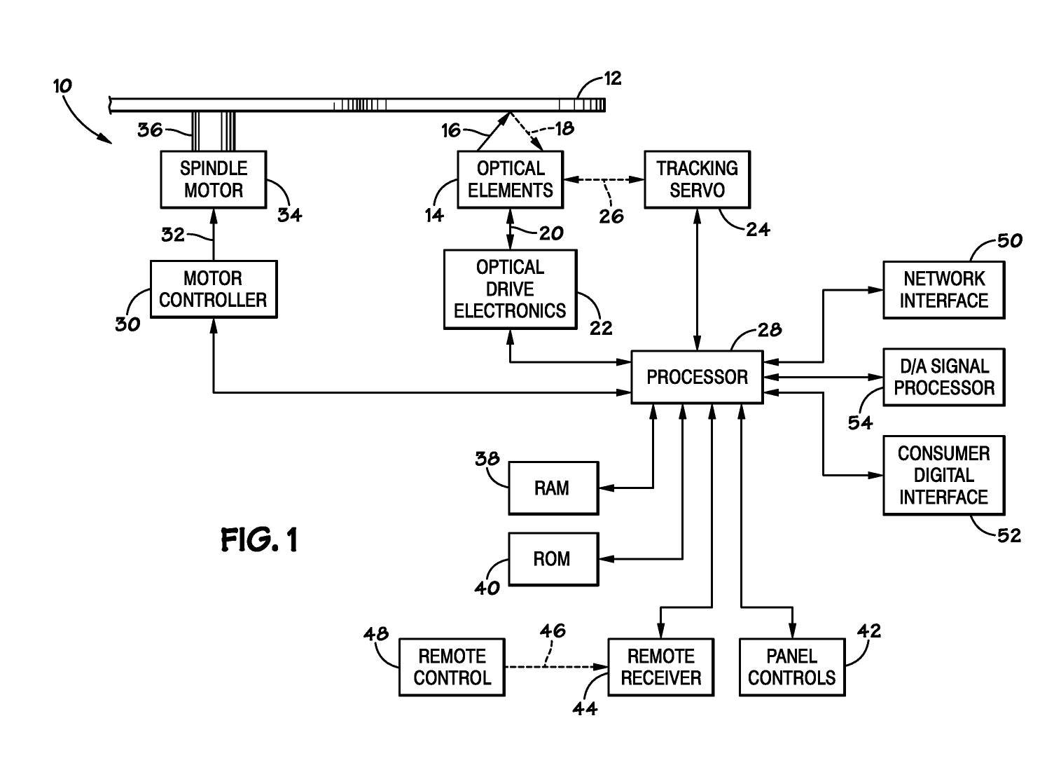

FIG. 1 provides a block diagram of a holographic storage system 10 that may be used to read data from holographic storage disks 12. The data stored on the holographic storage disk 12 is read by a series of optical elements 14, which project a reading beam 16 onto the holographic storage disk 12. A reflected reading beam 18 is picked up from the holographic storage disk 12 by the optical elements 14. The optical elements 14 may include any number of different elements designed to generate excitation beams (e.g., reading lasers), or other elements such as an optical head configured to focus the beams on the holographic storage disk 12 and/or detect the reflected reading beam 18 coming back from the holographic storage disk 12. The optical elements 14 are controlled through a coupling 20 to an optical drive electronics package 22. The optical drive electronics package 22 may include such units as power supplies for one or more laser systems, detection electronics to detect an electronic signal from the detector, analog-to-digital converters to convert the detected signal into a digital signal, and other units such as a bit predictor to predict when the detector signal is actually registering a bit value stored on the holographic storage disk 12.

The location of the optical elements 14 over the holographic storage disk 12 is controlled by a tracking servo 24 which has a mechanical actuator 26 configured to mechanically move or control the movement of the optical elements in a back and forth motion over the surface of the holographic storage disk 12. The optical drive electronics 22 and the tracking servo 24 are controlled by a processor 28. In some embodiments in accordance with the present techniques, the processor 28 may be capable of determining the position of the optical elements 14, based on sampling information which may be received by the optical elements 14 and fed back to the processor 28. The position of the optical elements 14 may be determined to enhance, amplify, and/or reduce interferences of the reflected reading beam 18 or compensate for movement and/or imperfections of the holographic disk 12. In some embodiments, the tracking servo 24 or the optical drive electronics 22 may be capable of determining the position of the optical elements 14 based on sampling information received by the optical elements 14.

The processor 28 also controls a motor controller 30 which provides the power 32 to a spindle motor 34. The spindle motor 34 is coupled to a spindle 36 that controls the rotational speed of the holographic storage disk 12. As the optical elements 14 are moved from the outside edge of the holographic storage disk 12 closer to the spindle 36, the rotational speed of the optical data disk may be increased by the processor 28. This may be performed to keep the data rate of the data from the holographic storage disk 12 essentially the same when the optical elements 14 are at the outer edge as when the optical elements are at the inner edge. The maximum rotational speed of the disk may be about 500 revolutions per minute (rpm), 1000 rpm, 1500 rpm, 3000 rpm, 5000 rpm, 10,000 rpm, or higher.

The processor 28 is connected to random access memory or RAM 38 and read only memory or ROM 40. The ROM 40 contains the programs that allow the processor 28 to control the tracking servo 24, optical drive electronics 22, and motor controller 30. In some embodiments, the ROM 40 includes a look-up table including information corresponding to a reading beam impinged on the holographic disk 12. For example, the look-up table may include a suitable reading beam power for each data layer of the disk 12, as will be further discussed. Further, the ROM 40 also contains programs that allow the processor 28 to analyze data from the optical drive electronics 22, which has been stored in the RAM 38, among others. As discussed in further detail herein, such analysis of the data stored in the RAM 38 may include, for example, demodulation, decoding or other functions necessary to convert the information from the holographic storage disk 12 into a data stream that may be used by other units.

If the holographic storage system 10 is a commercial unit, such as a consumer electronic device, it may have controls to allow the processor 28 to be accessed and controlled by a user. Such controls may take the form of panel controls 42, such as keyboards, program selection switches and the like. Further, control of the processor 28 may be performed by a remote receiver 44. The remote receiver 44 may be configured to receive a control signal 46 from a remote control 48. The control signal 46 may take the form of an infrared beam, an acoustic signal, or a radio signal, among others.

After the processor 28 has analyzed the data stored in the RAM 38 to generate a data stream, the data stream may be provided by the processor 28 to other units. For example, the data may be provided as a digital data stream through a network interface 50 to external digital units, such as computers or other devices located on an external network. Alternatively, the processor 28 may provide the digital data stream to a consumer electronics digital interface 52, such as a high-definition multi-media interface (HDMI), or other high-speed interfaces, such as a USB port, among others. The processor 28 may also have other connected interface units such as a digital-to-analog signal processor 54. The digital-to-analog signal processor 54 may allow the processor 28 to provide an analog signal for output to other types of devices, such as to an analog input signal on a television or to an audio signal input to an amplification system.

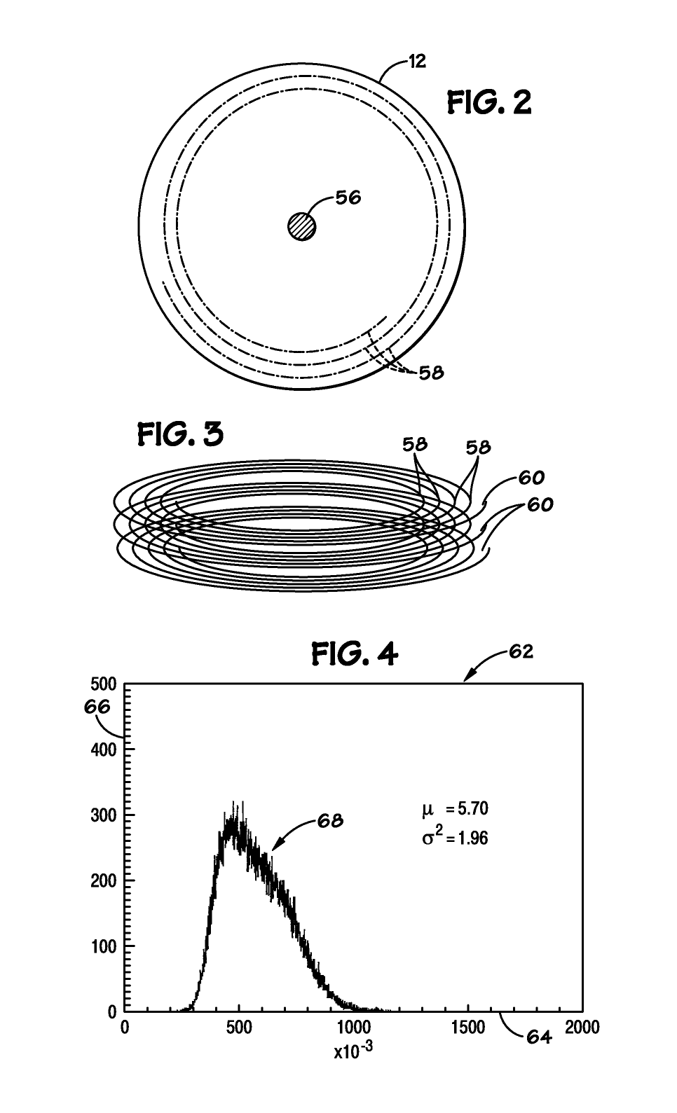

The system 10 may be used to read a holographic storage disk 12 containing data, as shown in FIG. 2. Generally, the holographic storage disk 12 is a flat, round disk with a recordable medium embedded in a transparent protective coating. The protective coating may be a transparent plastic, such as polycarbonate, polyacrylate, and the like. A spindle hole 56 of the disk 12 couples to the spindle (e.g., the spindle 36 of FIG. 1) to control the rotation speed of the disk 12. On each layer, data may be generally written in a sequential spiraling track 58 from the outer edge of the disk 12 to an inner limit, although circular tracks, or other configurations, may be used. The data layers may include any number of surfaces that may reflect light, such as the micro-holograms used for bit-wise holographic data storage or a reflective surface with pits and lands. An illustration of multiple data layers is provided in FIG. 3. Each of the multiple data layers 60 may have a sequential spiraling track 58. In some embodiments, a holographic disk 12 may have multiple (e.g., 50) data layers 60 which may each be between approximately 0.05 μm to 5 μm in thickness and be separated by approximately 0.5 μm to 250 μm.

Though multiple recording layers 60 increase the amount of data that can be stored, the layer-based configuration of the holographic disk 12 may result in a lower signal-to-noise ratio (SNR) and/or a higher bit error rate (BER) during holographic reading. More specifically, each holographic disk may be approximately 1.2 mm thick and may have multiple layers 60. Each of the multiple layers 60 may absorb energy from a light beam which propagates through it, thus decreasing the power of the light beam once it propagates through the layer 60. When a target data layer is to be read, a reading beam may be directed to and focused on the target layer. However, the reading beam must propagate from an optical head through each data layer 60 preceding the target data layer before focusing on the target data layer. Furthermore, the reflections of the reading beam, or the returned reading beam, propagate back from the target data layer and through the preceding layers 60 before it is received at the optical head. Therefore, a reading beam directed to a 50^{th} data layer from the optical head may propagate through 49 data layers 60, and the reflected reading beam may also propagate through the 49 data layers 60 before it is received at the optical head. Such propagation of the reading beam and reflected reading beam through the total 98 data layers 60 may result in a decrease of power (i.e., optical attenuation, also referred to as power attenuation) in the returned reading beam due to the absorption of the beam energy at each data layer 60. Attenuation of the returned reading beam may be represented by equation (1) below:

e^{-2(d/N)·α·n} equation (1)

where d is the thickness of the disk 12, N is the number of layers 60 in a disk 12, α is the absorption coefficient of the disk 12, and n is the layer on which the reading beam is focused. Assuming that a disk 12 is approximately 1.2 mm, a disk 12 has 50 layers, and the attenuation coefficient is 0.3 per mm, the relationship is approximately:

e^{-0.0147n} equation (2)

As represented by equations (1) and (2), the power of the returned reading beam is attenuated at each layer 60 through which the reading beam or returned reading beam propagates.

Moreover, and as represented in equations (1) and (2) above, reading beams directed to different data layers 60 (different n) result in variation in power of the returned reading beams due to the variation in power attenuated by propagating through different numbers of data layers 60. For example, a reading beam directed to a 2^{nd} data layer may result in a returned reading beam having less attenuation than a reading beam directed to the 50^{th} data layer. A graph illustrating the variance of returned reading beams in typical holographic reading techniques is provided in FIG. 4. The graph 62 represents a Monte-Carlo study of the power of returned reading beams from reading beams impinged on random positions in a holographic disk 12. The x-axis of the graph 62 is the signal strength 64 of the returned reading beam, and the y-axis of the graph 62 is the occurrence 66 of the signal strength 64. As determined from the shape of the Monte-Carlo results 68, the variance σ² in this study is approximately 1.96.

Such a variance represents the differences in attenuation from reading different portions (or layers 60) of a disk 12, and may result in using an increased threshold range for micro-hologram detection. More specifically, a returned reading beam may have a certain power, which indicates the presence of a micro-hologram in a data bit position. For example, a returned reading beam above a certain power threshold may represent a “1” or presence of a micro-hologram in that data bit position, and a returned reading beam below that power threshold may represent a “0” or absence of a micro-hologram in that data bit position. However, the power indicative of a present micro-hologram might be different for reading beams returned from different data layers 60. As such, detecting returned reading beams throughout all data layers 60 of the holographic disk 12 may involve a wide threshold range.

Using a wide threshold range may result in an increased bit error rate. For example, a holographic reading system 10 may use a threshold low enough (e.g., to account for reading beam attenuation) to enable the accurate micro-hologram detection of reading beams returned from a 50^{th} data layer. However, the same low threshold may also inaccurately determine that a micro-hologram is present on a position on a 2^{nd} data layer 60, even when no micro-hologram is actually present. For example, such a false positive on the 2^{nd} data layer may occur if random scattered light (e.g., from the disk surface) is received at the optical head. Alternatively, if a threshold is increased to prevent such a false positive micro-hologram detection from the 2^{nd} layer or from other layers 60 near the disk surface, the higher threshold may be too high to detect micro-hologram reflections from the 50^{th} data layer, thus increasing the probability of false negative micro-hologram detection from data layers 60 farther from the disk surface.

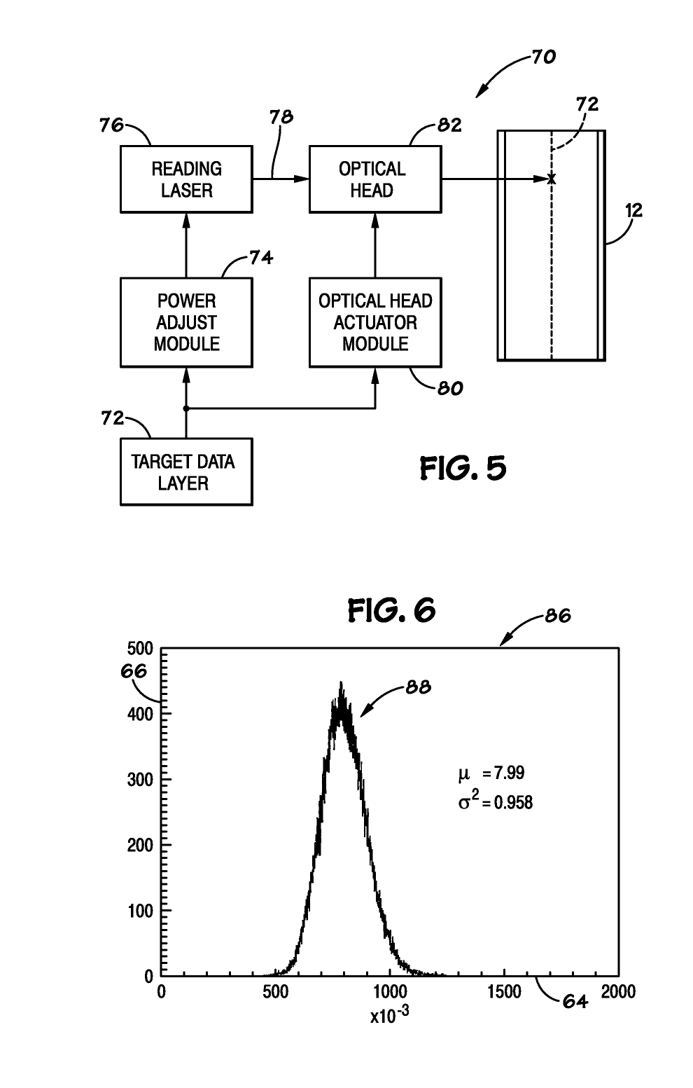

In one or more embodiments, holographic reading techniques may involve adjusting the power of the reading beam based on a data layer 60 to be read to reduce variance in the power of returned reading beams. One embodiment of adjusting reading beam power is provided in the schematic diagram of FIG. 5. The system 70 of FIG. 5 may be a portion of the system 10 generally discussed in FIG. 1, and may include a holographic disk 10 being read at a data bit position x from a data layer 72. In one embodiment, the data layer to be read 72, or the target data layer 72 is provided to a power adjust module 74 from a disk controller (e.g., a controller coupled to the processor 28 in FIG. 1). The power adjust module 74 may be included in the optical elements 14 block of FIG. 1, for example. The power adjust module 74 may adjust the power of a laser 76 (which may also be in the optical elements 14) based on the target data layer 72. For example, the power adjust module 74 may determine an appropriate power for a reading beam based on a look-up table which may provide an exact reading beam power or a range of reading beam powers appropriate for each data layer 60 or range of data layers 60 of a disk 12. In some embodiments, the look up table may be stored in memory (e.g., RAM 38 or ROM 40) accessible to the power adjust module 74. Based on the look up table, the laser 76 may emit a higher power reading beam 78 for a target data layer 72 which is farther from the surface of the disk 12 (e.g., the 50^{th} data layer 60) and may emit a lower power reading beam 78 for a target data layer 72 which is closer to the surface of the disk 12 (e.g., the 2^{nd} data layer 60). Further, in some embodiments, the power adjust module 74 may constantly monitor the reading process and may dynamically adjust the power of the laser 76 to emit the reading beam 78 at a particular power dependent on the current target data layer 72.

Providing the target data layer 72 to the system 70 may also result in adjusting the position of optical components in an optical head 82 which focuses the reading beam on the target data position x of the target data layer 72. In some embodiments, the optical head actuator module 80 may be configured to mechanically move various optical components (e.g., one or more lenses) in the optical head 82 based on the target data layer 72 and/or the corresponding power adjustment of the laser 76. Optical components in the optical head 82 may be moved to properly focus the power-adjusted reading beam 78 on the target data layer 72. Therefore, based on the provided target data layer 72, the power adjust module 74 may adjust the power of the laser 76 to affect the power of the reading beam 78 emitted by the laser 76, while the optical head actuator module 80 moves optical components in the optical head 82 to a depth suitable for focusing the power-adjusted reading beam 78 to the target data layer 72 on the disk 12.

It should be noted that while the embodiment illustrated in FIG. 5 using a power adjust module 74 to control the power of the laser 76 based on the target data layer 72, in other embodiments, other conditions or parameters of a reading beam may be adjusted to read from different target data layers 72. In accordance with the present techniques, reading from different target data layers 72 may involve adjusting various other reading conditions or parameters to improve a reading process based on the position of the target data layer 72 (e.g., such that the power returned by the reading beam from the target data layer 72 is not significantly attenuated). For example, in some embodiments, the reading beam may be emitted with different levels of energy, at different times, or according to different pulse shapes (e.g., beam shape with respect to power and time). Furthermore, different levels or thresholds for other parameters may be determined (e.g., by the processor 28) to improve a reading process based on the position of a particular target data layer 72.

Holographic reading techniques which adjust various parameters or conditions of the reading beam 78 based on a position of the target data layer 72 to be read may result in a decreased variance of the returned reading beam, as depicted in the graph of FIG. 6. FIG. 6 is a graph 86 representing a Monte-Carlo study of the power of returned reading beams from impinging power-adjusted reading beams on random positions in a holographic disk 12. For example, the power of the reading beams may be adjusted in accordance with the system 70 of FIG. 5. The x-axis of the graph 86 is the signal strength 64 of the returned reading beam, and the y-axis of the graph 86 is the occurrence 66 of the signal strength 64. As determined from the shape of the Monte-Carlo results 88 for the returned power-adjusted reading beams, the variance σ² in this study is approximately 0.958, which is approximately half of the variance in the study (in FIG. 4) where reading beams are not adjusted for different target data layers.

A smaller variance corresponds to smaller differences in attenuation due to reading different portions (or different target data layers 72) of a disk 12. Therefore, a smaller variance may correspond to a smaller threshold range for micro-hologram detection. As discussed, using a smaller threshold range for micro-hologram detection may reduce the bit error rate in holographic reading processes.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of reading data from a holographic disk, the method comprising:
adjusting a previous power of a reading beam to a new power based on a depth of a target data layer; and
emitting the reading beam at the new power to the target data layer in the disk.

2. The method of claim 1, comprising determining the new power based on the depth of the target data layer.

3. The method of claim 2, wherein determining the new power comprises using a look-up table to determine the new power corresponding to the depth of the target data layer.

4. The method of claim 1, wherein adjusting the previous power of the reading beam to the new power comprises increasing the previous power to the new power when the target data layer is farther from a first surface of the disk than a previous target data layer.

5. The method of claim 1, wherein adjusting the previous power of the reading beam to the new power comprises decreasing the previous power to the new power when the target data layer is closer to a first surface of the disk.

6. The method of claim 1, wherein adjusting the previous power of the reading beam to the new power comprises utilizing a power adjust module to adjust a laser to emit the reading beam at the new power.

7. The method of claim 1, comprising transmitting the reading beam at the new power to an optical head.

8. The method of claim 7, wherein emitting the reading beam at the new power to the target data layer comprises using the optical head to focus the reading beam at the new power to a target data position in the target data layer.

9. The method of claim 8, comprising adjusting a position of components in the optical head based on at least one of the new power of the reading beam and the target data layer.

10. The method of claim 9, wherein adjusting the position of the components in the optical head comprises utilizing an actuator to move the components.

11. The method of claim 10, wherein the actuator is configured to move the components in an axial direction with respect to a surface of the disk.

12. A system for reading micro-holograms from a holographic disk, the system comprising:
a power adjust module configured to:
receive an instruction corresponding to a target data layer to be read from the disk; and
adjust a power of a reading beam from a first power to a second power based on the instruction;
an optical head configured to direct the reading beam from a previous data layer of the disk to the target data layer and focus the reading beam on the target data layer; and
an actuator configured to move a component of the optical head.

13. The system of claim 12, wherein the first power is higher than the second power when the previous data layer is farther from the optical head than the target data layer.

14. The system of claim 12, wherein the first power is lower than the second power when the previous data layer is closer to the optical head than the target data layer.

15. The system of claim 12, comprising a controller configured to dynamically provide the instruction to the power adjust module, and wherein the power adjust module is configured to dynamically adjust the power of the reading beam.

16. The system of claim 12, comprising a look-up table in a memory of the system, wherein the look-up table comprises individual instructions corresponding to each respective data layer of the disk.

17. A method, comprising:
determining a reading power of a reading beam suitable for reading a target data layer based on a plurality of factors including a distance of the target data layer from a top surface of the disk; and
transmitting the reading beam at the reading power to the target data layer in the disk.

18. The method of claim 17, wherein the method is dynamic throughout a reading process of the disk.

19. The method of claim 17, wherein determining the reading power comprises looking up a corresponding reading power for the target data layer from a look-up table.

20. The method of claim 17, comprising:
determining a focusing position of an optical head suitable for focusing the reading beam on a target data position on the target data layer;
actuating one or more components of the optical head based on the determined focusing position; and
focusing the reading beam on the target data position.

21. The method of claim 20, wherein the reading power is a first power when the target data layer is in a first position, and wherein the reading power is a second power when the target data layer is in a second position, wherein the first power is lower than the second power, and wherein the first position is closer to the optical head than the second position.

22. A method, comprising:
determining a condition of a reading beam suitable for reading a target data layer based on a distance of the target data layer from a top surface of the holographic disk, such that a returned power of a returned reading beam is not significantly attenuated; and
transmitting the reading beam at the determined condition to the target data layer in the holographic disk.

23. The method of claim 22, wherein determining the condition of the reading beam comprises calculating an energy threshold for the reading beam suitable for reading the target data layer, and wherein transmitting the reading beam comprises transmitting the reading beam at the calculated energy threshold to the target data layer.

24. The method of claim 22, wherein determining the condition of the reading beam comprises calculating a reading time in which the reading beam is directed at the a target data position in the target data layer, and wherein transmitting the reading beam comprises transmitting the reading beam for the reading time at the target data position.
